(19) United States
(12) Patent Application Publication
(10) Pub. No.: US 2011/0181486 A1
(43) Pub. Date: Jul. 28, 2011

(54) WIRELESS IC DEVICE

(75) Inventor: Noboru KATO, Nagaokakyo-shi (JP)

(73) Assignee: MURATA MANUFACTURING CO., LTD., Nagaokakyo-shi (JP)

(21) Appl. No.: 13/080,781

(22) Filed: Apr. 6, 2011

Related U.S. Application Data
(63) Continuation of application No. PCT/JP2009/067140, filed on Oct. 1, 2009.

(30) Foreign Application Priority Data
Oct. 24, 2008 (JP) 2008-274771

(51) Int. Cl. H01Q 1/50

(52) U.S. Cl. 343/850

(57) ABSTRACT

A wireless IC device has a resonant frequency that is hardly altered or affected by external influences and reliably communicates with a reader/writer. The wireless IC device includes a wireless IC chip arranged to process a radio signal, a feeder circuit board coupled to the wireless IC chip and including a feeder circuit, and a radiation electrode arranged at least one principal surface of the feeder circuit board. The feeder circuit board includes a magnetic material and has the feeder circuit disposed therein. The radiation electrode is disposed on at least one principal surface of the feeder circuit board so as to be electromagnetically coupled to the feeder circuit and includes at least two open ends. The wireless IC chip is coupled to the radiation electrode through the feeder circuit and communicates with a reader/writer using HF band frequency.

### BACKGROUND OF THE INVENTION

1. Field of the Invention

The present invention relates to wireless integrated circuit (IC) devices including a wireless IC and a radiation plate. More particularly, the present invention relates to a wireless IC device preferably for use in a radio frequency identification (RFID) system performing communication using an HF band frequency.

2. Description of the Related Art

In recent years, an RFID system has been developed as an article management system in which electromagnetic-field-based contactless communication is performed between a reader/writer generating an induction field and a wireless IC tag (hereinafter, also referred to as a wireless IC device) affixed to an article and storing predetermined information so that the predetermined information is transmitted.

The wireless IC tag used in this RFID system includes a wireless IC chip that processes a predetermined radio signal and a radiation plate that transmits and receives the radio signal. For example, a wireless IC tag disclosed in Japanese Unexamined Patent Application Publication No. 2007-102348 is known.

The wireless IC tag disclosed in Japanese Unexamined Patent Application Publication No. 2007-102348 is constituted by a multilayer antenna pattern and an IC chip. Swirling electrodes are disposed on a plurality of layers to form the antenna pattern. A resonance circuit is constituted by inductance generated by the electrodes and inter-electrode capacitance and capacitance of the IC chip. The resonant frequency of this resonance circuit is set equal to communication frequency, e.g., 13.56 MHz. The wireless IC tag communicates with a reader/writer through the antenna pattern.

However, the wireless IC tag has the following problems. Since the antenna pattern is covered with a protection film but is exposed to the outside, a magnetic field generated by the antenna pattern leaks to the outside and an inductance value of the antenna pattern changes because of influences of the dielectric constant and the shape of articles attached with the tag. Variance of the resonant frequency due to the inductance value change causes a communication failure.

To prevent the magnetic field from leaking to the outside and to increase the inductance value, the antenna pattern may be disposed in a magnetic body, such as ferrite. However, when the antenna pattern is disposed completely within the magnetic body, the magnetic field is trapped inside the magnetic body and communication cannot be performed.

### SUMMARY OF THE INVENTION

Preferred embodiments of the present invention provide a wireless IC device having a resonant frequency that is hardly altered or affected by external influences and that reliably communicates with a reader/writer.

A wireless IC device according to a preferred embodiment of the present invention includes a wireless IC arranged to process a radio signal; a feeder circuit board including a magnetic material and coupled to the wireless IC, the feeder circuit board including a feeder circuit that includes an inductance element; and a radiation electrode arranged on at least one principal surface of the feeder circuit board to be electromagnetically coupled to the feeder circuit and including at least two adjacent open ends.

The wireless IC is preferably coupled to the radiation electrode through the feeder circuit in the wireless IC device, so that wireless communication with a reader/writer is performed using an HF band frequency. Since the feeder circuit is disposed in the feeder circuit board including a magnetic material, an inductance value is increased and a resonant frequency is hardly altered or affected by external influences. A magnetic field is trapped when the feeder circuit is arranged in a magnetic body. However, since the feeder circuit is electromagnetically coupled to the radiation electrode disposed on at least one principal surface of the feeder circuit board, current at the resonant frequency of the feeder circuit flows through the radiation electrode having at least two adjacent open ends and wireless communication at the resonant frequency of the feeder circuit can be performed through the radiation electrode.

In accordance with a wireless IC device according to a preferred embodiment of the present invention, since a feeder circuit is disposed in a magnetic body, an inductance value is increased and the resonant frequency is hardly altered or affected by external influences. As a result, the wireless IC device reliably communicates with a reader/writer through a radiation electrode.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a wireless IC device according to a first preferred embodiment of the present invention.

FIGS. 2A and 2B are a top view and a bottom view, respectively illustrating the wireless IC device according to the first preferred embodiment of the present invention.

FIG. 3 is an equivalent circuit diagram of a feeder circuit.

Each of FIGS. 4A, 4B, and 4C is a bottom view of a feeder circuit board illustrating an alteration of a radiation electrode.

FIGS. 5A and 5B are a top view and a bottom view, respectively illustrating a wireless IC device according to a second preferred embodiment of the present invention.

FIG. 6 is a sectional view illustrating a wireless IC device according to a third preferred embodiment of the present invention.

FIG. 7 is an exploded plan view of a feeder circuit board.

FIG. 8 is an explanatory diagram illustrating a magnetic field generated around an inductance element.

FIG. 9 is an explanatory diagram illustrating a wireless IC device according to a fourth preferred embodiment of the present invention.

FIG. 10 is an explanatory diagram illustrating a wireless IC device according to a fifth preferred embodiment of the present invention.

### DETAILED DESCRIPTION OF THE PREFERRED EMBODIMENTS

Preferred embodiments of wireless IC devices according to the present invention will be described below with reference to the accompanying drawings. In each drawing, the same reference numerals are used to refer to common components and elements to avoid redundant description.

### First Preferred Embodiment

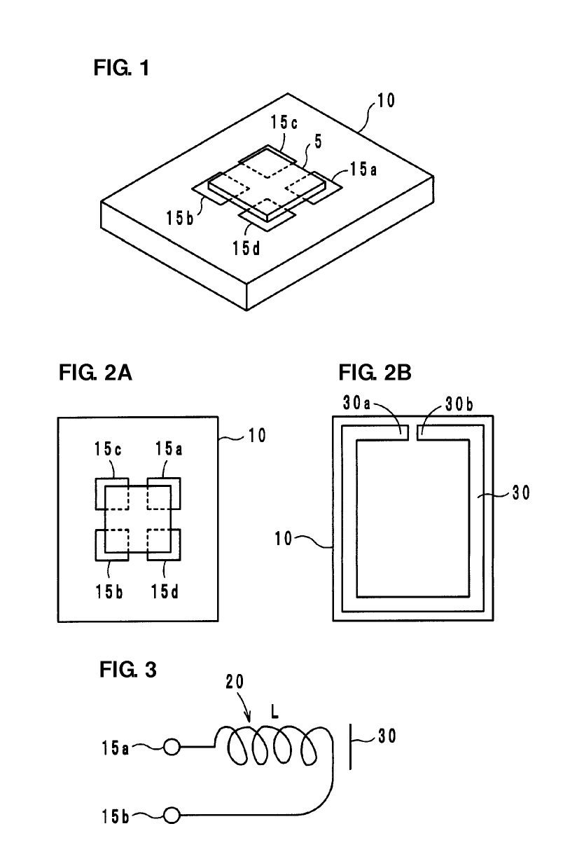

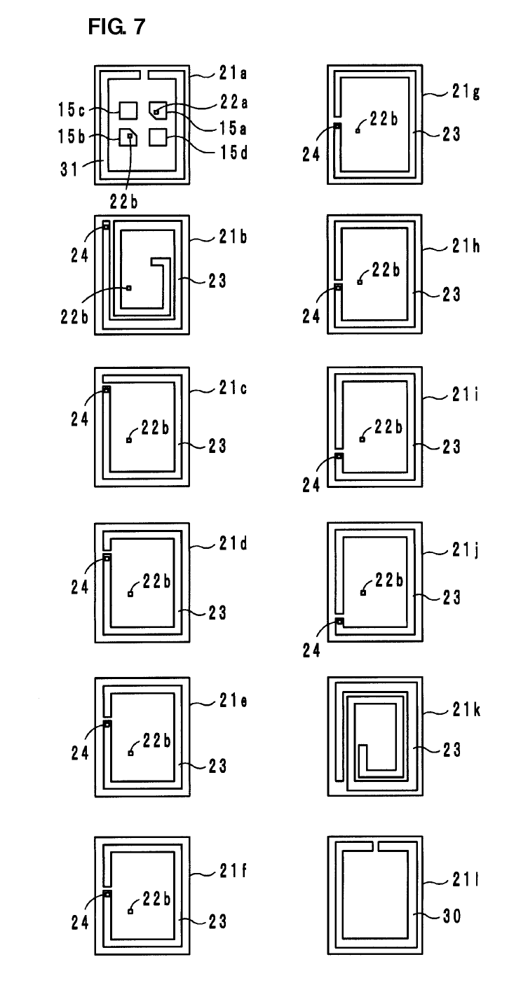

As illustrated in FIG. 1, a wireless IC device according to a first preferred embodiment of the present invention includes a wireless IC chip 5 configured to process a radio signal, a feeder circuit board 10, and a radiation electrode 30. The feeder circuit board 10 includes a feeder circuit 20 (a detail thereof will be described later with reference to FIG. 7) that is coupled to the wireless IC chip 5 and includes an inductance element L. The radiation electrode 30 is disposed on a lower surface of the feeder circuit board 10 to be electromagnetically coupled to the feeder circuit 20 and has two adjacent open ends 30a and 30b.

The wireless IC chip 5 includes circuits, such as a clock circuit, a logic circuit, and a memory circuit, for example, and stores necessary information. A pair of input/output terminal electrodes and a pair of mounting terminal electrodes (not shown) are preferably disposed on a lower surface of the wireless IC chip 5. The pair of input/output terminal electrodes and the pair of mounting terminal electrodes are electrically connected to feeder terminal electrodes 15a and 15b and mounting electrodes 15c and 15d on the feeder circuit board 10 through soldering or the like, respectively. The feeder terminal electrodes 15a and 15b are electrically connected to the feeder circuit 20 included in the feeder circuit board 10.

The feeder circuit board 10 is preferably made of materials including a magnetic material, such as ferrite, for example. The feeder circuit 20 is included in a magnetic body. As illustrated by an equivalent circuit in FIG. 3, the feeder circuit 20 includes the inductance element L. One end of the inductance element L is connected to the feeder terminal electrode 15a, whereas the other end thereof is connected to the feeder terminal electrode 15b.

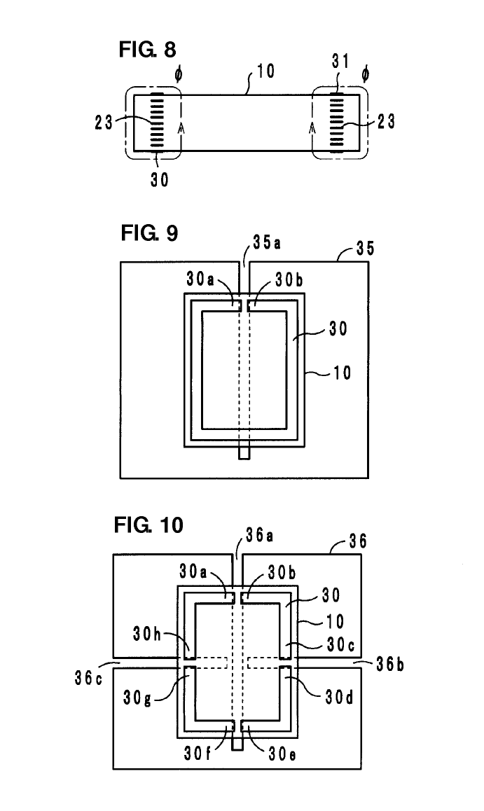

As illustrated in FIG. 2B, the radiation electrode 30 is disposed on the lower surface of the feeder circuit board 10 as a cutout loop electrode having the open ends 30a and 30b. This radiation electrode 30 is arranged to overlap the feeder circuit 20 (a loop electrode 23) provided in the feeder circuit board 10 in plan view (see FIG. 8). The radiation electrode 30 and the feeder circuit 20 are electromagnetically coupled.

In the wireless IC device of the first preferred embodiment having the above configuration, the feeder circuit 20 has a predetermined resonant frequency (e.g., around 13.56 MHz) in the HF band owing to inductance of the inductance element L and inter-electrode capacitance thereof. The wireless IC chip 5 is coupled to the radiation electrode 30 through the feeder circuit 20, so that wireless communication is performed with a reader/writer.

Since the feeder circuit 20, which is disposed in the feeder circuit board 10 including a magnetic material, has a large inductance value, the board 10 can be downsized and the resonant frequency is hardly altered or affected by external influences. A relative dielectric constant of the feeder circuit board 10 is, for example, 70 with respect to a relative dielectric constant of air equal to 1. Accordingly, when the feeder circuit 20 is arranged in the magnetic body, a magnetic field is trapped therein. However, since the feeder circuit 20 is electromagnetically coupled to the radiation electrode 30 disposed on a lower surface of the feeder circuit board 10, round current at the resonant frequency of the feeder circuit 20 flows through the radiation electrode 30 including the two adjacent open ends 30a and 30b and generates a magnetic field around the radiation electrode 30. This magnetic field allows wireless communication at the resonant frequency of the feeder circuit 20 to be performed.

That is, since the feeder circuit 20 is disposed in the magnetic body, the resonant frequency is hardly altered by external influences. Additionally, communication can be performed for sure with a reader/writer through the radiation electrode 30 that is arranged on a surface of the magnetic body to be electromagnetically coupled to the feeder circuit 20.

In addition, since the feeder circuit 20 is not directly electrically connected to the radiation electrode 30 but is electromagnetically coupled thereto, static electrical charge (low frequency noise) is not applied to the wireless IC chip 5 from the radiation electrode 30 and the wireless IC chip 5 is protected from the static electrical charge.

Meanwhile, in order to generate the magnetic field from the radiation electrode 30, the resonant frequency of the radiation electrode 30 is preferably higher than that of the feeder circuit 20. The resonant frequency of the radiation electrode 30 is determined mainly by relative dielectric constant and relative magnetic permeability of the feeder circuit board 10, length of the radiation electrode 30, and interelectrode stray capacitance involving the shape of the radiation electrode 30. Additionally, the wireless IC chip 5 is preferably arranged inside the radiation electrode 30. Since the magnetic field at a central portion of the loop radiation electrode 30 is weak, the wireless IC chip 5 (particularly, the terminal electrodes 15a-15d) is prevented from disturbing the radiation of the magnetic field.

The radiation electrode 30 may have various shapes as long as at least one electrode having at least two open ends is bent. As illustrated in FIG. 2B, the radiation electrode 30 may have a substantially C-shape or the open ends 30a and 30b may overlap as illustrated in FIGS. 4A and 4B. Alternatively, as illustrated in FIG. 4C, the radiation electrode may be divided into four portions and include open ends 30a-30h. Additionally, the radiation electrode 30 may include four linear portions.

### Second Preferred Embodiment

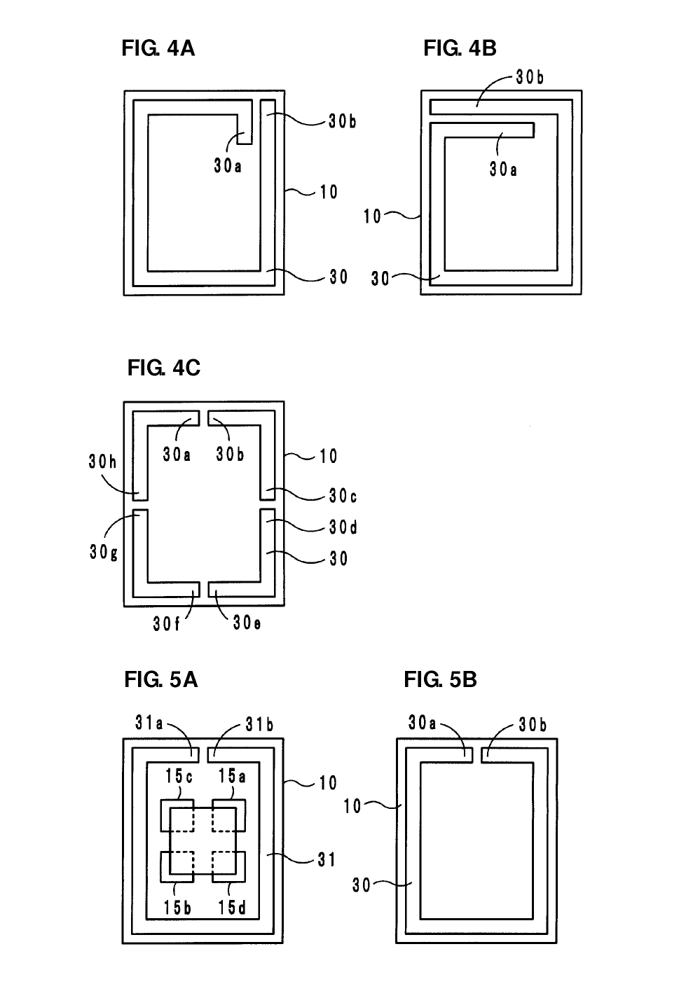

As illustrated in FIG. 5, a wireless IC device according to a second preferred embodiment includes another radiation electrode 31 (including open ends 31a and 31b) disposed on an upper surface of a feeder circuit board 10 in addition to a radiation electrode 30 disposed on a lower surface of the feeder circuit board 10. Disposing the radiation electrodes 30 and 31 on the lower and upper surfaces of the board 10, respectively, increases radiant quantities of a magnetic field and improves gain.

### Third Preferred Embodiment 3

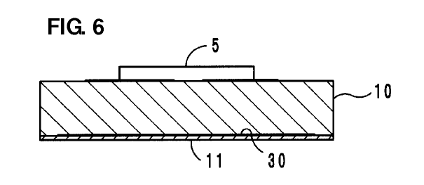

As illustrated in FIG. 6, in a wireless IC device according to a third preferred embodiment 3, a radiation electrode 30 disposed on a lower surface of a feeder circuit board 10 preferably made of a magnetic material is covered with a non-magnetic material layer 11. The radiation electrode 31 disposed on the upper surface of the feeder circuit board 10 illustrated in FIG. 5A may be covered with a non-magnetic material layer, such as a sealing resin, for example. Covering the radiation electrode 30 with the non-magnetic material layer prevents the radiation electrode 30 from oxidizing and corroding and improves reliability.

A configuration of the feeder circuit board 10, in particular, a specific example of the included feeder circuit 20 (the inductance element L), will be described next with reference to FIG. 7. The description will be given on this feeder circuit board 10 with an assumption that the radiation electrodes 30 and 31 are disposed on the lower and upper surfaces of the board 10 illustrated in FIG. 5.

Magnetic body (ferrite) sheets 21a-21k are laminated from the upper surface of the feeder circuit board 10, whereas a non-magnetic body (e.g., ferrite having a relative magnetic permeability equal to 1) sheet 21l is laminated on the lower surface thereof. The terminal electrodes 15a-15d, via hole conductors 22a and 22b, and the radiation electrode 31 are formed on the sheet 21a of the first layer. A loop electrode 23 and via hole conductors 22b and 24 are formed on the sheets 21b-21j of the second-tenth layers. The loop electrode 23 is formed on the sheet 21k of the eleventh layer. The radiation electrode 30 is formed on the sheet 21l of the twelfth layer (i.e., a bottom layer).

The sheets 21a-21l are laminated, whereby the loop electrode 23 is helically connected through the via hole conductor 24 to constitute the inductance element L. One end of this inductance element L is connected to the terminal electrode 15a through the via hole conductor 22a, whereas the other end thereof is connected to the terminal electrode 15b through the via hole conductor 22b.

A magnetic field φ illustrated in FIG. 8, which is a sectional view of the feeder circuit board 10, is generated around the inductance element L having the above configuration. When the radiation electrodes 30 and 31 are arranged at positions where this magnetic field is strong, electromagnetic coupling between the radiation electrodes and the feeder circuit 20 gets stronger. More specifically, the radiation electrodes 30 and 31 are preferably arranged to overlap the feeder circuit 20 (the loop electrode 23) in plan view. Additionally, when the radiation electrodes are arranged at marginal portions of the upper and lower surfaces of the board 10, a radio wave is more easily radiated into the air.

### Fourth and Fifth Preferred Embodiments

Wireless IC devices according to the fourth and fifth preferred embodiments include radiation plates 35 and 36, respectively, in addition to the radiation electrodes 30 and 31.

A wireless IC device illustrated in FIG. 9 includes the radiation plate 35 for the radiation electrode 30 disposed on the feeder circuit board 10 illustrated in FIG. 2. A recess portion 35a for the open ends 30a and 30b of the radiation electrode 30 is formed in the radiation plate 35. A magnetic field is radiated from the recess portion 35a.

A wireless IC device illustrated in FIG. 10 includes the radiation plate 36 for the radiation electrode 30 disposed on the feeder circuit board 10 illustrated in FIG. 4C. Recess portions 36a, 36b, and 36c for the open ends 30a-30h of the radiation electrode 30 are formed in the radiation plate 36. A magnetic field is radiated from the recess portions 36a, 36b, and 36c.

### Other Preferred Embodiments

The wireless IC devices according to the present invention are not limited to the foregoing preferred embodiments and can be variously modified within a scope of the spirit thereof.

In particular, in addition to mounting the wireless IC chip 5 on the feeder circuit board 10, a wireless IC may be included in the feeder circuit board 10. Additionally, the wireless IC may be integrated into the feeder circuit 20 using a process that is the same as that of the feeder circuit 20, for example.

As described above, various preferred embodiments of the present invention are useful for wireless IC devices and are particularly advantageous in that resonant frequency is hardly altered or affected by external influences and reliably communicates with a reader/writer can be performed.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A wireless IC device, comprising:
a wireless IC arranged to process a radio signal;
a feeder circuit board coupled to the wireless IC and including a feeder circuit that includes an inductance element, the feeder circuit board including a magnetic material; and
a radiation electrode disposed on at least one principal surface of the feeder circuit board so as to be electromagnetically coupled to the feeder circuit, the radiation electrode including at least two adjacent open ends.

2. The wireless IC device according to claim 1, wherein the radiation electrode is arranged on two opposing principal surfaces of the feeder circuit board.

3. The wireless IC device according to claim 1, wherein the radiation electrode is a cutout loop electrode including the open ends.

4. The wireless IC device according to claim 1, wherein the radiation electrode is arranged to overlap the feeder circuit provided in the feeder circuit board in plan view.

5. The wireless IC device according to claim 1, wherein the radiation electrode is arranged at a marginal portion of the principal surface of the feeder circuit board.

6. The wireless IC device according to claim 1, wherein the radiation electrode is covered with a non-magnetic material layer.

7. The wireless IC device according to claim 1, wherein resonant frequency of the radiation electrode is higher than resonant frequency of the feeder circuit.

8. The wireless IC device according to claim 1, wherein the wireless IC is arranged inside the radiation electrode.

9. The wireless IC device according to claim 1, further comprising a radiation plate electromagnetically coupled to the radiation electrode.
